(19) United States
(12) Patent Application Publication
(10) Pub. No.: US 2013/0262136 A1
(43) Pub. Date: Oct. 3, 2013

(54) Method And System For Improving Quality Of Care And Safety And Continuous Physician And Patient Learning

(71) Applicant: DIAGNOSISONE, INC., Lowell, MA (US)

(72) Inventors: Fauzia Khan, Shrewsbury, MA (US); Mansoor Khan, Shrewsbury, MA (US); Ahmad Kasmieh, Hollis, NH (US)

(73) Assignee: DiagnosisOne, Inc., Lowell, MA (US)

(21) Appl. No.: 13/851,739

(22) Filed: Mar. 27, 2013

Related U.S. Application Data
(60) Provisional application No. 61/616,752, filed on Mar. 28, 2012.

(51) Int. Cl. G06F 19/00

(52) U.S. Cl. CPC G06F 19/324
USPC 705/2

(57) ABSTRACT

This invention focuses not on archiving an increasing number of medical literature articles, but having a defined number of learning modules, which when matched against certain predefined criteria, issue a learning recommendation to a physician. Systems and method embodiments include determining a pattern of medical treatment, analyzing the pattern with current medical data, and recommending, based on the analysis, at least one of a treatment, a continuing medical education, a learning module, and medical literature.

### RELATED APPLICATION(S)

This application claims the benefit of U.S. Provisional Application No. 61/616,752, filed on Mar. 28, 2012.

The entire teachings of the above application(s) are incorporated herein by reference.

### BACKGROUND OF THE INVENTION

There exists in the medical industry a problem of growing volumes, or “exploding,” medical literature. Auto-archiving systems provide, to a degree, a solution to this problem. Auto-archiving systems can organize a myriad of medical literature, as described in inventions such as Moore, (U.S. Pub. No. 2011/0178813) and in art literature (Forgia et al., Hospital Performance in Brazil). The archived medical literature can be retrieved based on search term(s) entered or identified by the care providers.

### SUMMARY OF THE INVENTION

This invention focuses not on archiving an increasing number of medical literature articles, but having a defined number of learning modules, which when matched against certain predefined criteria, issue a learning recommendation to a physician.

In one embodiment, a method includes determining a physician pattern of medical treatment, analyzing the pattern with current medical data, and recommending, based on the analysis, at least one of a treatment, a continuing medical education, a learning module, and medical literature.

In another embodiment, the method can further include analyzing patient records of a patient and recommending treatment information to the patient based on patient preferences in the patient records.

In another embodiment, a system includes a pattern determination module configured to determined a pattern of medical treatment based on retrieved electronic medical records data of patients of a physician. A pattern analysis module compares the pattern to current medical data. A recommendation module is configured to recommend, based on the analysis, at least one of a treatment, a continuing medical education course, a learning module, and medical literature.

In one aspect, the invention provides a method, including the steps of: determining the occurrence of a clinical event or series of events for a patient based on medical data related to the patient; identifying continuing medical education information (CME) related to the clinical event or series of events; and notifying a healthcare professional related to the patient of the occurrence of the clinical event or series of events and providing the healthcare professional access to the CME.

In one embodiment, the method further includes the step of analyzing the series of events to detect clinical patterns and care gaps and identifying CME related to those clinical patterns and care gaps.

In one embodiment, the method further provides the healthcare professional access to the data about the clinical patterns and care gaps and access to the related CMEs.

In one embodiment, the method further provides the healthcare professional with an option to express interest in learning about similar clinical patterns and care gaps.

In one embodiment, the method further includes providing the healthcare professional with information on the professional's metrics and how they have improved after access to the CME.

In one embodiment, the method further includes determining whether the healthcare professional accesses the CME and generating a record of the access.

In one embodiment, the method further includes providing the healthcare professional with information based on the record of the healthcare professional's access of the CME.

In one embodiment, the healthcare professional is a member of an accrediting organization and the method further includes providing the accrediting organization information based on the record of the healthcare professional's access of the CME.

In one embodiment, the healthcare professional is a member of an accrediting organization and the method further includes selecting the CME based on the membership of the healthcare professional in the accrediting organization.

In one embodiment, the step of identifying includes selecting the CME from among CME that has been previously accessed by the healthcare professional and CME that has not been previously accessed by the healthcare professional and the step of providing the healthcare professional access includes providing the healthcare professional access to the CME that had not previously been accessed.

In one embodiment, the step of identifying includes selecting the CME from among CME that has been previously provided to the healthcare professional for access, but not accessed by the healthcare professional, and CME that has not been previously provided to the healthcare professional for access, and the step of providing the healthcare professional access includes providing the healthcare professional access to the CME that had been provided for access but not previously been accessed.

In one embodiment, the accrediting organization is a first accrediting organization, the healthcare professional is a member of a second, different accrediting organization, the CME includes CME from each of the first and second accrediting organizations and the step of selecting the CME includes selecting the CME based on an accreditation status of the healthcare professional with the first and second accrediting organizations.

In one embodiment, the steps of determining and identifying are performed using at least one electronic processor and the steps of notifying and providing the healthcare professional access to the CME are performed using at least one electronic display.

In one embodiment, the step of notifying is performed during a consultation between the healthcare professional and the patient.

In one embodiment, the medical data is obtained from a result of a laboratory test of the patient and the step of notifying occurs less than 60 minutes, less than 30 minutes, or less than 15 minutes after a determination of the result of the laboratory test.

In one embodiment, the laboratory test is a laboratory test that has been ordered by the healthcare professional.

In one embodiment, the method further includes generating a recommendation for a medical intervention for the patient related to the clinical event and notifying the healthcare professional of the recommendation, and the CME relates to the medical intervention.

In one embodiment, the medical intervention is a medication, a diagnostic test, a medical appliance, or combination thereof.

In one embodiment, the CME includes information generated by a provider of the medication, diagnostic test, and/or medical appliance.

In one embodiment, the method further includes notifying, using at least one electronic display, the provider of the medication, diagnostic test, and/or medical appliance of the occurrence of the step of providing the healthcare professional access to the CME.

In one embodiment, the method further includes notifying the provider of the medication, diagnostic test, and/or medical appliance of whether the healthcare professional accessed the CME.

In one embodiment, the method further includes electronically providing the healthcare professional the ability to prescribe the medication, order the diagnostic test, and/or order the medical appliance.

In one embodiment, the method further includes electronically providing the healthcare professional the ability to generate educational information related to the medication, order the diagnostic test, and/or order the medical appliance for the patient.

In one embodiment, the step of electronically providing is performed when the healthcare professional is in the presence of the patient.

In another aspect, the invention provides an electronic system comprising at least one electronic processor and at least one electronic display, and the electronic system is configured to perform any of the steps of the previously described methods of the invention.

In another aspect, the invention provides an electronic storage medium including, electronically stored therein, code configured to perform any of the steps of the previously described methods of the invention.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is diagram illustrating an example embodiment of a display showing a review screen view for a physician to show medical logic of a learning recommendation.

FIG. 2 is a diagram illustrating an example embodiment of generating and displaying a screen view of pertinent bibliographic citations.

FIG. 3 is a diagram illustrating a process employed by the present invention to form and generate the recommendation based on various factors.

FIG. 4 is a tier diagram illustrating an example embodiment of the present invention employing a multi-tier architecture.

FIG. 5 is block diagram illustrating an example embodiment of the present invention employed to utilize web services to implement healthcare related functionality.

FIGS. 6a and 6b are schematic block diagrams of a computer network and system deploying an embodiment of the present invention.

### DETAILED DESCRIPTION OF THE INVENTION

A description of example embodiments of the invention follows.

In one embodiment, a system identifies areas of knowledge of a care provider, physician, or patient that would benefit from supplemental education or training. The embodied system identifies (and subsequently fills in) gaps of knowledge by analyzing patient-level and population-level clinical and billing data to provide a context appropriate learning module at the right time. The system focuses on detecting patterns in a care provider's practice, physician's practice, or physician group's practice, such that when a pattern meets certain predefined criteria or a threshold, the system issues specific learning recommendations to the care provider, physician or physician's practice group. The care provider, physician or patient can access the learning modules at the point of care in real time or save them for access at a later time.

The system and corresponding methods described herein can:

1) Systematically identify individual patients and physicians, or other care providers such as Physician assistants, nurses, paramedics etc., in specific clinical situations that can benefit from physician and patient learning and action.

2) The system can identify areas where either the physician or the patient or both can benefit from relevant knowledge of standards of care and new advances in clinical science and practice.

3) The system can identify an area based on specific criteria predefined in the knowledge base. Hierarchical rules focus on signs of advancing illness, medication safety and failure to achieve evidence based goals of care.

4) Physician learning modules are linked to rules and processes which start from the most specific rules and follow hierarchal schema to a broader set of thresholds. The learning modules, for instance, can begin analyzing a single patient or condition and then apply the rules broadly to multiple patients or conditions.

5) Once the criteria for a learning opportunity are met, a learning recommendation can be sent to the care provider, physician and/or the patient. These learning recommendations can include:

a) For care providers:

i) Materials for earning Continuing Medical Education (CME) credits or Continuing Education Units (CEU).

ii) Orders, treatment or diagnostic recommendations for specific patients

iii) Risk scores and utilization summary at point of order and other points in the clinical workflow.

iv) Summary of clinical indicators.

v) Opportunity to analyze the provider's entire panel of patients using population analytics.

b) For Patients:

i) Educational material on his or her medical condition(s). In one embodiment, the system can further provide educational materials on specific combinations of medical conditions to provide synergistic commendations.

ii) Strategies for managing a chronic illness.

iii) Real time dialogue with case managers, clinical experts.

iv) Facilitate appointment scheduling with the medical practice.

v) Strategies for managing multiple chronic illnesses, accounting for synergistic effects of the multiple chronic illnesses.

6) The system tracks which materials care providers and patients have accessed and solicits responses from the care providers and patients. The system maintains a database of physician and patient learning, analyzes the responses, and predicts a next set of learning objectives, and provides or recommends materials needed to achieve the set of learning objectives.

7) The system continues to evaluate and respond with recommendations at the physician level and the provider organization level.

8) CMEs and educational content can be in various media format such as written text, images, video or a combination of all, and may or may not have sponsored links.

Exemplification

In one embodiment, the system is employed with a care provider treating a patient dealing with anticoagulation. This embodiment can be employed in the following example:

1) The system identifies a patient who has been on warfarin for several years, but had erratic laboratory monitoring and an out-of-range International Normalized Ratio (INR). The system detects that the patient's demographics, missing labs, and out of range values may warrant physician education and/or patient education.

2) System issues alerts at various points in the clinical workflow including at the point of order.

3) Physician and/or patient can access the learning session. In one embodiment, a learning session can be accessed at a designated machine or any internet enabled computer apparatus.

4) Information gathered in the learning session is stored in the database.

5) If the system detects another patient with a similar profile, a more advanced learning session is made available based on the information stored from the first patient.

6) The physician or care provider can log into the learning center directly and review related library of content.

7) Patients can log into a patient education learning center and review related content.

In another example embodiment, the system is employed by a care provider involved with diabetes care, i.e. a diabetic patient. This embodiment can be employed in the following example:

1) The system identifies a patient with both poor diabetes control as measured by a HbA1C lab test and poor blood pressure control. Rules identify that the patient has not had the expected four visits to the medical practice over the past year, and has had only one HbA1C measurement out of the expected two to four measurements.

2) The system sends to the physician an offer to review the latest guidelines on combination therapy of insulin and oral diabetes medications.

3) The system offers to the physician a report on the glycemic control and blood pressure control of all of the diabetic patients in his/her practice.

4) The system sends to the patient educational material on diabetes medication adherence and glucose testing. The patient receives information on low sodium diet, strategies to enhance exercise, and a medication guide on his/her blood pressure medications.

The system sends to the patient an offer to schedule a visit with the diabetes educator in the medical group.

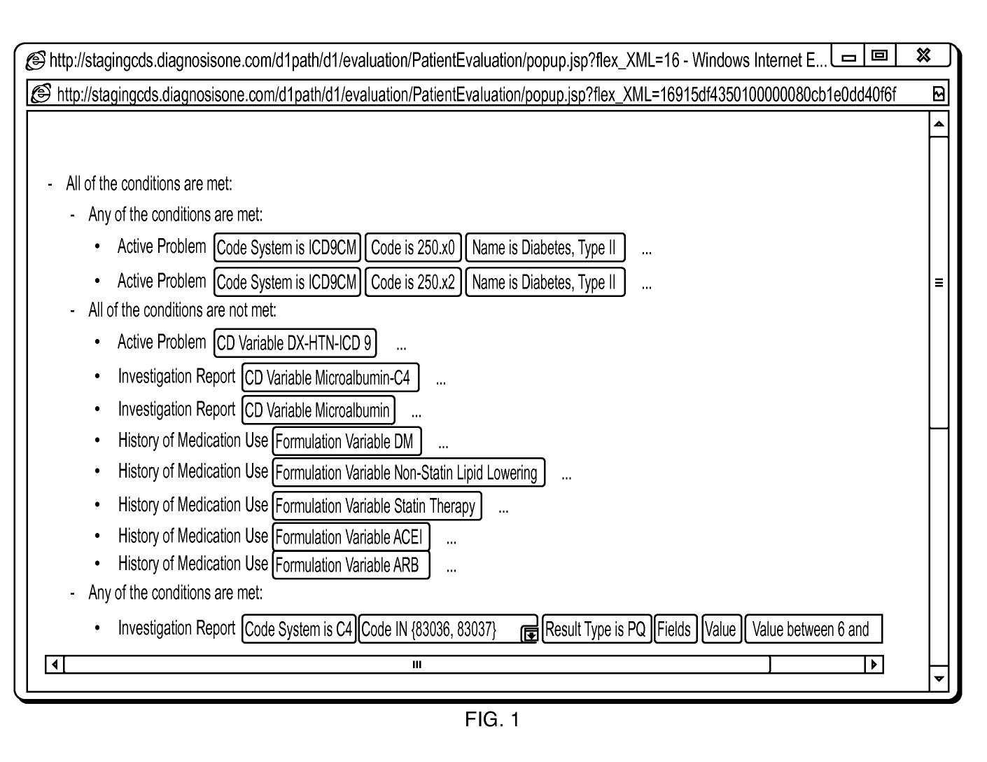

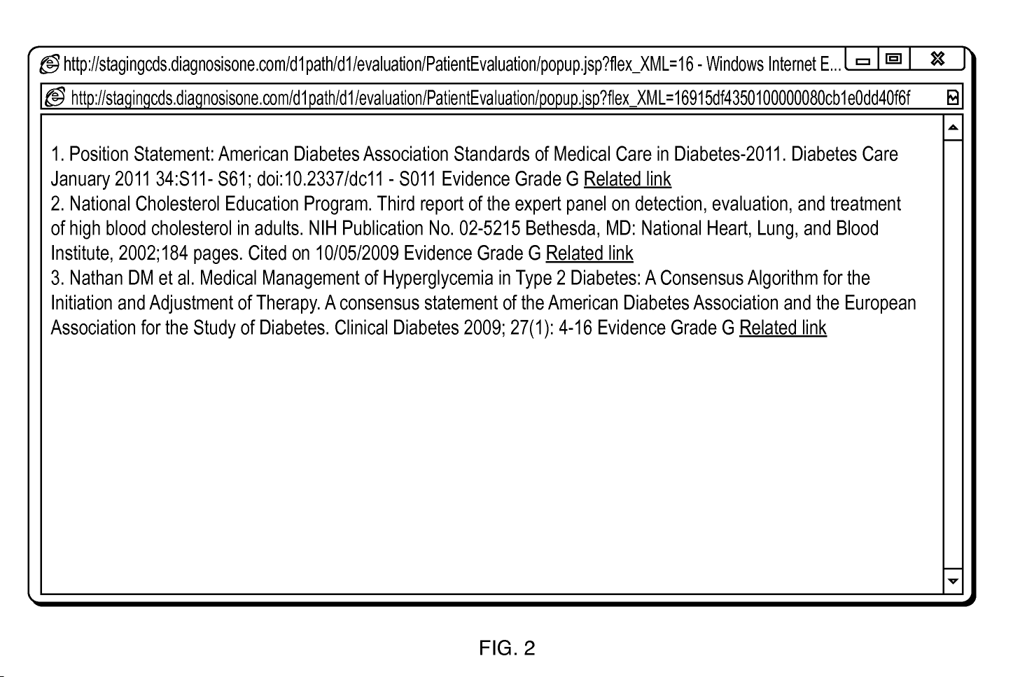

The system can analyze population and patient data and send a learning recommendation back to the physician. The care provider can review the algorithmic medical logic (FIG. 1) that was the basis for the recommendation, the learning material, and bibliographic citations (FIG. 2). The system as illustrated in FIG. 1 generates a screen view to the physician showing the medical logic of the learning recommendation. The system generates and displays the screen view of FIG. 2 showing bibliographic citations.

Advantages and benefits of the invention include at least one of the following:

Improving treatment compliance by engaging patients and enabling them to understand their personal health condition(s).

Gaining insight into factors of diet, activity, risk avoidance and medication compliance, which help patients improve their health and well being.

Identifying potential side effects of a treatment and signs of progression of disease in time to address these areas of concern before they become problematic.

Empowering physicians and other health care providers with enhanced clinical skills.

Applying learning through improved treatment of individual patients.

Focusing on evidence based learning.

Acquiring tools to analyze populations of patients within a physician's (or practice group's) own panel of patients.

Intervening on patient safety issues in a timely and targeted manner.

Optimizing provider organization in regards to clinical quality and decreased costs

Creating a continuous learning environment with engaged providers and staff.

Aligning institutional goals for group level education.

Identifying opportunities for workflow improvement.

Managing risk and reducing group liability.

Empowering physicians and nurses to receive required annual CME or CEU credits at their convenience and in a real-life setting rather than at a costly health conference.

In one embodiment, the system provides the following computer-based features and functionality:

1) Rules

a) Rules can be authored and managed.

b) Rules can be triggered for simulation and testing purposes.

c) There are rules for catalog management.

d) There are rules for implementing search operations (searching functions).

2) CME and Patient education Media

a) A library of CME and patient education media can be managed.

b) CME credits and learning module unit can be managed.

c) Files can be classified.

d) Education media can be searched by

i. Attributes

ii. Patient

iii. Physician

iv. Practice

e) Education media can be associated with rules and triggered in a simulation or hypothetical scenario playing.

3) User management

4) Business intelligence

a) Data validation, processing and normalization

b) Longitudinal patient record maintenance

c) Report management and generation

d) Delivery

e) User visibility control

5) Integration with an external source, such as an external media resource library, external CME program, or external learning modules

a) Web services

b) Web parts and components

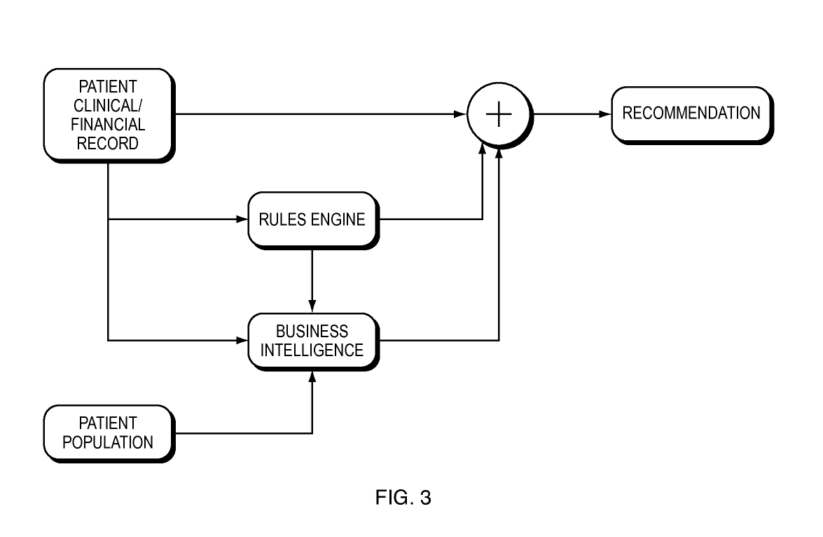

With reference to FIG. 3, depicted is a process employed by embodiments of the present invention for identifying the recommendation based on various factors.

The system, e.g., the Medical Learning system, is built upon a smartPath™ platform (from assignee DiagnosisOne), within an existing rules engine. The smartPath™ platform, the backbone for all of the system's service modules, uses the latest enterprise technologies from Microsoft, Oracle and Red Hat in one embodiment. The system brings these technologies together in a powerful healthcare platform built on Health Level 7 (HL7) v3.0 to provide users with rich internet applications and scalable web services to address advanced healthcare challenges in an ever-changing market in one embodiment.

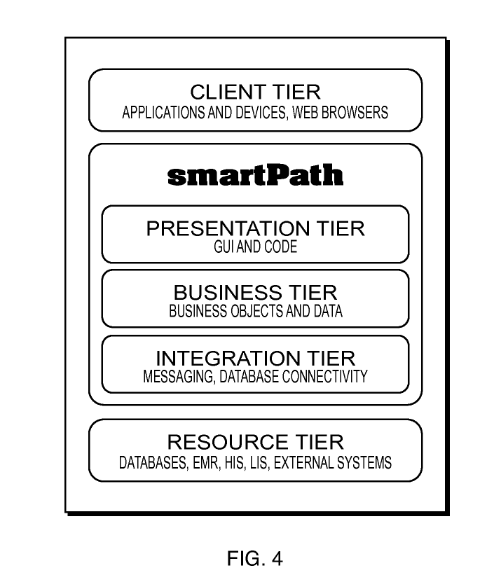

The platform architecture follows a standard multi-tiered approach to application architecture as depicted in FIG. 4, where a tier is a logical partition with a unique responsibility in the system. The realm of the application architecture and functionality includes a Presentation Tier, Business Layer, and an Integration Tier. A Client Tier and a Resource Tiers interact with the application architecture.

FIG. 4 is a tier diagram illustrating an example embodiment of the present invention employing a multi-tier architecture.

The multi-tier architecture enables the application to be deployed in clustered environments. One or more servers can be added to the appropriate tier at any time to increase the capacity, high availability and the performance of the overall system.

In one embodiment, a Service Oriented Architecture (SOA) is the application framework that defines how Applicant's business functionality is logically grouped and implemented as a suite of loosely coupled web-based services, which expose their functionality through discoverable interfaces. The services promote reuse and are consumed by both the Business Tier of the platform and external client applications. Such services provide their consumers with a level of abstraction of underlying implementation technology and operating system. The services are interoperable where consumers implement using various technologies and programming languages that can invoke them. Similar to the multi-tier architecture, SOA enables web services to be deployed in clustered environments. One or more servers can be added to host a service at any time to increase its capacity, high availability and performance.

Components

A deep technology background informs our sophisticated approach to partitioning, visualization, services and rules. Our Presentation Tier is implemented as Rich Internet Applications (RIA) web portals and sites. The user interfaces are implemented using HTML, JavaScript, JQuery, AJAX, FLASH, Silverlight, JSP and ASPX technologies. These result in well-designed, rich and user-friendly interfaces that streamline the users work, minimize data entry errors and provide a delightful, user-friendly experience. The smartPath platform utilizes enterprise class Business Intelligence (BI) software to maintain:

HL7 V3 RIM based data warehouses, marts, and cubes

Automatic and manual integration services Extract, Transport and Load (ETL) processes

Reports, charts and dashboard

The result to the end user is a fast, rich and relevant visualization of the clinical data.

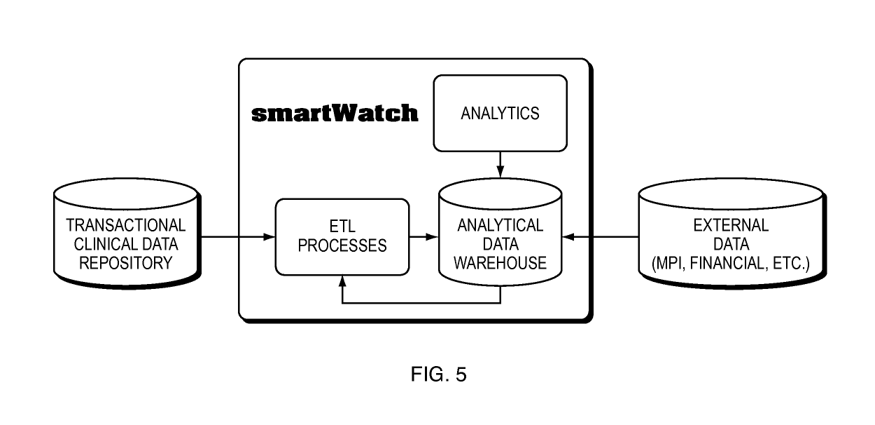

FIG. 5 is block diagram of an example embodiment of the present invention formed of the above components and utilizing several SOA web services to implement healthcare related functionality described in FIGS. 1-3.

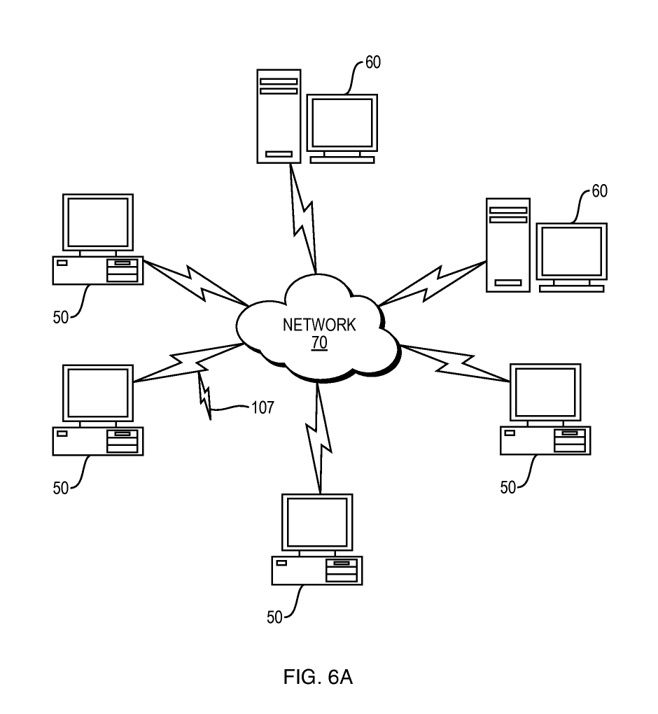

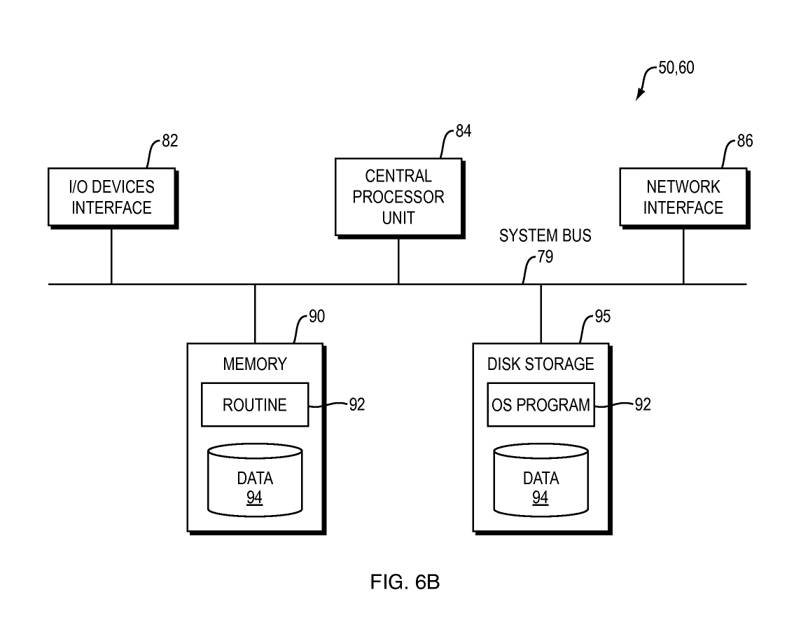

FIG. 6a illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 6b is a diagram of the internal structure of a computer (e.g., client processor/device 50 or server computers 60) in the computer system of FIG. 6a. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6a). Memory 90 provides volatile storage for computer software instructions 92 and data 94 used to implement an embodiment of the present invention (e.g., medical learning system, learning recommendation engine and supporting code detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to example embodiments thereof, it will be understood by those skilled in the art that various changes in form and details may be made therein without departing from the scope of the invention encompassed by the appended claims.

What is claimed is:

1. A method, comprising:
determining the occurrence of a clinical event or series of events for a patient based on medical data related to the patient;
identifying continuing medical education information (CME) related to the clinical event or series of events;
notifying a healthcare professional related to the patient of the occurrence of the clinical event or series of events and providing the healthcare professional access to the CME.

2. The method of claim 1, further comprising analyzing the series of events to detect clinical patterns and care gaps and identifying CME related to those clinical patterns and care gaps.

3. The method of claim 2, further providing the healthcare professional access to the data about the clinical patterns and care gaps and access to the related CMEs.

4. The method of claim 3, further providing the healthcare professional with an option to express interest in learning about similar clinical patterns and care gaps.

5. The method of claim 1, further comprising providing the healthcare professional with information on the professional's metrics and how they have improved after access to the CME.

6. The method of claim 1, further comprising determining whether the healthcare professional accesses the CME and generating a record of the access.

7. The method of claim 6, further comprising providing the healthcare professional with information based on the record of the healthcare professional's access of the CME.

8. The method of claim 6 or claim 7, wherein the healthcare professional is a member of an accrediting organization and the method further comprises providing the accrediting organization information based on the record of the healthcare professional's access of the CME.

9. The method of claim 1, wherein the healthcare professional is a member of an accrediting organization and the method further comprises selecting the CME based on the membership of the healthcare professional in the accrediting organization.

10. The method of claim 1, wherein the step of identifying comprises selecting the CME from among CME that has been previously accessed by the healthcare professional and CME that has not been previously accessed by the healthcare professional and the step of providing the healthcare professional access comprises providing the healthcare professional access to the CME that had not previously been accessed.

11. The method of claim 1, wherein the step of identifying comprises selecting the CME from among CME that has been previously provided to the healthcare professional for access, but not accessed by the healthcare professional, and CME that has not been previously provided to the healthcare professional for access and the step of providing the healthcare professional access comprises providing the healthcare professional access to the CME that had been provided for access but not previously been accessed.

12. The method of claim 9, wherein the accrediting organization is a first accrediting organization and further wherein the healthcare professional is a member of a second, different accrediting organization and the CME comprises CME from each of the first and second accrediting organizations and wherein the step of selecting the CME comprises selecting the CME based on an accreditation status of the healthcare professional with the first and second accrediting organizations.

13. The method of claim 1, wherein the steps of determining and identifying are performed using at least one electronic processor and the steps of notifying and providing the healthcare professional access to the CME are performed using at least one electronic display.

14. The method of claim 1, wherein the step of notifying is performed during a consultation between the healthcare professional and the patient.

15. The method of claim 1, wherein the medical data is obtained from a result of a laboratory test of the patient and the step of notifying occurs less than 60 minutes, less than 30 minutes, or less than 15 minutes after a determination of the result of the laboratory test.

16. The method of claim 15, wherein the laboratory test is a laboratory test that has been ordered by the healthcare professional.

17. The method of claim 1, further comprising generating a recommendation for a medical intervention for the patient related to the clinical event and notifying the healthcare professional of the recommendation and wherein the CME relates to the medical intervention.

18. The method of claim 17, wherein the medical intervention is a medication, a diagnostic test, a medical appliance, or combination thereof.

19. The method of claim 18, wherein the CME includes information generated by a provider of the medication, diagnostic test, and/or medical appliance.

20. The method of claim 19, wherein the method further comprises notifying, using at least one electronic display, the provider of the medication, diagnostic test, and/or medical appliance of the occurrence of the step of providing the healthcare professional access to the CME.

21. The method of claim 19 or 20, wherein the method further comprises notifying the provider of the medication, diagnostic test, and/or medical appliance of whether the healthcare professional accessed the CME.

22. The method of claim 19, further comprising electronically providing the healthcare professional the ability to prescribe the medication, order the diagnostic test, and/or order the medical appliance.

23. The method of claim 19, further comprising electronically providing the healthcare professional the ability to generate educational information related to the medication, order the diagnostic test, and/or order the medical appliance for the patient.

24. The method of claim 23, wherein the step of electronically providing is performed when the healthcare professional is in the presence of the patient.

25. An electronic system comprising at least one electronic processor and at least one electronic display wherein the electronic system is configured to perform any of the steps of claim 1.

26. An electronic storage medium comprising, electronically stored therein, code configured to perform any of the steps of claim 1.
